(19) United States
(12) Patent Application Publication
(10) Pub. No.: US 2002/0188694 A1
(43) Pub. Date: Dec. 12, 2002

(54) Cached enabled implicit personalization system and method

(76) Inventor: Allen Yu, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 09/876,417

(22) Filed: Jun. 7, 2001

(51) Int. Cl. G06F 15/16; G06F 17/24

(52) U.S. Cl. 709/218; 707/501.1

(57) ABSTRACT

A method for personalizing digital objects and content associated with a web page that is sent to users across a network. The personalization takes place based on relationships between categories, keywords and resources in the system. The first step includes accessing content categories that are arranged hierarchically and are linked to a plurality of keywords. The next step is associating a resource with a plurality of keywords. Then each user's activities are tracked by storing an activity level for keywords associated with each resource. The users' activities are tracked as the user accesses the resources. Another step is determining a user's content preferences based on the activity level for keywords across multiple categories. The final step is delivering the digital objects associated with a web page to users based on the user's content preferences across multiple categories.

### FIELD OF THE INVENTION

The present invention relates generally to the implicit personalization of web site information presented to a user. More particularly, the present invention relates to personalizing digital objects in cached web pages that are presented to a user.

### BACKGROUND OF THE INVENTION

In today's highly competitive Internet environment, web sites need to be more than just mass publication pages if they want to attract and retain visitors. Successful websites need to be personalized and customized to meet individual users' interests and needs. Effective personalization should be automatically generated and content driven.

There are two basic types of personalization: explicit and implicit personalization. In the first case, customization is driven by information the user has explicitly given. This includes the situation where a user fills out a survey or form and a website is customized based on the information given by the user. In the second case, personalization is driven implicitly by electronic observation or data collection about the user's behavior.

An example of personalization helps to better understand the context of web site personalization. Suppose a web site caters to users who are interested in outdoor sports and the web site sells sporting goods and/or provides sporting news. The web site naturally wants have a constantly changing list of merchandise, seminars, news, and clinics it promotes. Instead of having each user view the same static home page, with the same complete list of currently active promotions, the web site wants each user to see a customized page based on the user's interests.

The reason the web site wants each visitor or user to see a customized page is to avoid the risk of overloading a user with generic promotions. Otherwise, the user may tune out all the web site's promotions categorically. It is more effective to custom deliver promotions or content to a user based on the user's interest. In addition, custom information delivery is a better use of precious web page screen space. Of course, regardless of the degree of customization, the web site needs to be flexible enough that anyone can (when they have the time) browse and discover new sections on the web site.

As mentioned, there are two general types of personalization: explicit and implicit personalization. An example of each as applied to the outdoors sports store example is given below.

Explicit personalization requires a user to register and answer a survey to identify the user's interests. In the outdoor sports store example, the web site asks the user to identify sports in which the user is interested (e.g., biking, tennis, basketball, running, etc.). One shortcoming of this approach is that many people prefer to browse websites anonymously or do not want to register until they are ready to purchase. A second shortcoming of the registration approach is that even after a user has already registered, the user's interests may change. However, most users do not keep their user profiles current.

Implicit personalization does not require a user to take proactive actions like filling out a survey. The user is implicitly tracked through their user ID and login or some other method of unique identification (e.g., a cookie). An implicit system only requires the web site or web server to track the areas that a user has visited. For example, if a user spends 60% of their time on the outdoor sports website in the tennis racquet section, he is probably a tennis player. The benefit of implicit personalization is that users need not be registered for it to work. In addition, users are not burdened with the responsibility to keep their profiles current. In either case, knowing that a visitor is a tennis player is invaluable when it comes to the personalization of content, such as promotions.

To produce a customized and personalized web page for each user, the system dynamically generates the web page by requesting information from a database and combining that information with web page formatting and content. The problem is that because each user receives a different personalized page, every page needs to be dynamically generated. However, the cost of dynamically generating a page for each user is high and often takes a heavy toll on server performance.

A more careful observation of typical website usage reveals that not every page needs to be dynamically generated to deliver customized content. In fact, most of the personalized content that is individually crafted for a single user can often be shared with other users that have analogous interests. By sharing often requested components of personalized pages, the web server does not need to make additional database calls when another user makes similar requests. This is because the cached information can be retrieved from the web site's local file system. The performance enhancement can be significant since database access is “expensive” and forms a major bottleneck of website performance.

In such a file based caching system, a mechanism exists to delete the appropriate cached file when relevant content in the database changes. When a deletion occurs, the next web page call to the changed page results in a new database call and the updated results are stored in a newly cached file. Any subsequent requests for that specific page will result in file retrievals, without any database calls, until the relevant data in the database changes. When the database content changes again, the cycle repeats.

Web servers that allow results from database calls to be cached on its file system are often referred to as file-based cache-enabled web servers. An example of one widely used cache-enabled web server is Vignette Story Server® which uses the TCL computer language. Other web server technologies also offer caching capabilities, including the JSP (Java Server Page) and ASP (Microsoft Active Server Page) platforms.

Although the technical details of the caching mechanisms are not important in this current discussion, it is relevant to understand why caching is so valuable. Caching reusable database results in a web server's file system greatly enhances the overall site performance because most requests are satisfied by relatively “fast” file system retrievals rather than relatively “slow” database calls. To gain a significant performance boost, one needs to design file-based cache-enabled websites to share the smallest possible subset of personalized digital components and/or web pages with the widest audience possible. Equivalently, it is important to increase the overall ratio of file system retrievals to database calls to obtain the greatest performance gain possible.

### SUMMARY OF THE INVENTION

The invention provides a method for personalizing digital objects and content associated with a web page that is sent to users across a network. The first step includes accessing personalization categories, each of which has a plurality of keywords associated with it, that are arranged hierarchically. The next step is associating a resource (e.g., a digital document or digital object) with plurality of personalization keywords. Then each user's activities are tracked separately by storing an activity level with respect to each keyword. The users' activities are tracked as the user accesses the resources. The steps above relate to the logging activities associated the current invention. Another step relates to the interpretive activities of the system and involves determining a user's content preferences based on the activity level recorded for all relevant keywords across multiple categories. The final step is delivering the digital objects associated with a web page to users based on the user's content preferences across multiple categories. A method, based on caching, is taught to enable this final step to be done as efficiently as possible.

Another aspect of the present invention includes a method for personalizing digital objects and content associated with a web page by associating the resources with multiple keywords. The first step is accessing content categories that divide digital objects into content groups. Another step is linking a plurality of personalization keywords to resources or content categories (i.e., a grouping of a resources). A content category or resource can be associated with a plurality of keywords in separate personalization categories. This enables the capability to deliver the same digital objects to separate users based on users' activities in the separate categories. The personalization keywords can belong to completely unrelated personalization categories, which allow the possibility of tracking a resource under two completely independent contexts. It will then be possible to personalize the same items in completely different ways depending on the histories of independent users.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a flow chart of the steps taken to generate a personalized web page with cached components;

FIG. 2 is a database entity and relationship diagram illustrating a database structure for a cache-enabled implicit personalization system;

FIG. 3 is a block diagram that illustrates the relationships between hierarchical categories, keywords and resources.

### DETAILED DESCRIPTION

For the purposes of promoting an understanding of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure are to be considered within the scope of the invention.

This system and method disclosed in this description will be demonstrated in the context of an implementation of a functional, high performance, implicitly personalized system. An implicitly personalized system is a personalization system based on “click-stream” analysis, where personalization of digital objects provided to a user is based on the electronic observation of user activity within a website (i.e., the sections of the website the customer visits, etc.). Digital objects are generally defined as web pages, executable scripts, graphic objects, sounds, video, documents, animations, executable objects, and similar objects which may be sent to a user from a web site. Although the concepts disclosed here are applied to HTML formatted web pages in the following embodiment, the concepts disclosed can apply equally to other types of electronic documents. These other documents include but are not limited to low resolution documents that are used with mobile and wireless devices such as PDA's, pagers, and mobile phones. In addition, this invention may also be applied to audio documents that serve devices such as those used by the visually impaired and applied to hyper documents that serve the various virtual reality devices and Internet enabled appliances. Similarly, cached components need not be stored in the HTML format as shown in the embodiment, but they can be stored in more flexible formats such as XML or even in proprietary binary formats.

The current invention describes a method of organizing and categorizing information to enable powerful personalization features that were not possible before. Specifically, these features are: 1) Cross-category comparisons (provided by a hierarchical personalization categorization scheme); 2) Decreased maintenance costs; 3) Overlapping categorization schemes; 4.) Easy integration with high performance, cache-enabled servers (2-4 are provided by a flexible, dynamic, ad hoc personalization categorization scheme); and 5) More accurate tracking of user interests (provided by a scheme to more effectively tag resources). The full advantages of the current invention are best seen in an embodiment that implements the integration of a personalization categorization scheme based on ideas expressed in the current invention with a high performance, cache-enabled server system. A more detailed discussion of the steps needed to deliver a personalized page in the context of a high performance, cache-enabled server will follow next.

A generic cache-enabled personalization system includes at least three processing components: a database component, a personalization component (both logging and interpreter), and a cached data component.

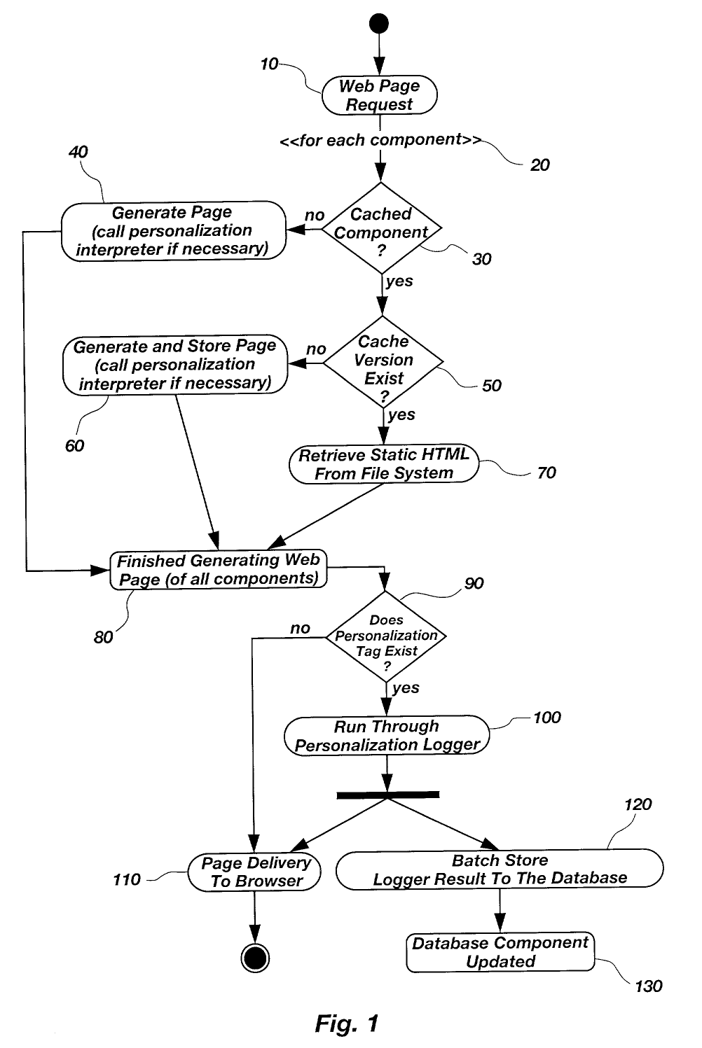

FIG. 1 is a flow chart of the steps taken by the processing components of a cache-enabled personalization system to generate a personalized web page with cached digital objects. The chart illustrates the context in which the system components interact and shows the logical flow of the system. The flow chart begins with a web page request 10 and shows the steps required for page delivery. A processing component in the flow chart refers to a software routine that results in the generation of HTML snippets. A cached component refers to a component whose HTML can be cached so similar future requests can be satisfied by reading from the server's file system, rather than by making a call to the server's database system. A given web page can consist of any number of digital objects or components, but for performance and maintenance reasons these are usually kept to fewer than 6-8 per web page. It should be realized that cached components in this description are discussed generally in the context of cached HTML files, but other types of files can be used. Cached components or digital objects can be stored in formats other than HTML, such as XML, Java script, CGI script or a binary file that caches data representing information residing on an actual web page.

Referring again to FIG. 1, after a web page request is received, each of the page's components 20 need to be retrieved from the cache or generated by a database call. The component processing must be completed before the page as a whole can be generated and sent to the client for display. If the personalization system determines that the component or components are not cached components 30, then it generates the components for the page 40. The actual version of a personalized component to be displayed is determined by querying the personalization interpreter. The personalization interpreter will be discussed in detail later.

If the components are cached components, then the system decides if that cached component exists in the cache 50. If the cache version of the component does not presently exist, then the page must be generated and stored in the cache 60. If the component or page exists in the cache, then the page or component will be retrieved from the file system 70. Of course, retrieving a cached component is much faster than generating the components.

At this point, the components in the web page are complete 80. After page generation, but before page delivery, the system determines whether personalization tags (or keywords) exist in the web page to be delivered 90. If they do, the page and/or components are run through the personalization logger 100, which is responsible for implicitly logging and tracking the sections of a site the user has visited using the personalization tags. The personalization logger stores the user's activity in a database component 120, where counts are kept with respect to both the customer identity and the personalization tags. It is only after properly logging the user visit that the generated web page is finally sent to the user's browser for display 110. It is important to note that the personalization interpreter customizes content during page generation, using information cumulatively stored by the personalization logger. In addition, it should also be understood that a web page might consist of multiple personalized cached components or sub-components, each of which can be shared among unrelated users.

One of the main deficiencies of current personalization systems is that the personalization tags used for tracking user interests are organized in a flat, inflexible structure referred to as flat category-keyword schema. In this prior art scheme, a category is used as a logical construction for grouping related keywords. As an example, the category “mountain bikes” can be constructed to group a set of related keywords such as “hard tails,” “full suspension,” and “rigid body.” Keywords are statically associated with their category, and modifications are generally not allowed in order to preserve the counts already collected. With a flat category-keyword scheme, it is the keywords or personalization tags along with the customer identity that provide the context under which interest counts are recorded. The main benefits a flat category-keyword schema provides are ease of use and ease of implementation.

By organizing sets of related keywords into categories, personalization systems allow useful personalization analysis to be carried out. The most important of these personalization analyses are the “min” and “max” functions. For the above example, a max (“mountain bikes”) analysis might return the keyword “full suspension” for a mountain bicyclist who has shown the greatest interests in full suspension bikes.

Although the flat category-keyword schema provides a straightforward framework under which to carry out personalization analyses, it also results in several severe limitations. One limitation is that it does not allow for cross-category comparisons. The flat category-keyword scheme allows straightforward comparison of counts within a category but no mechanism for meaningful comparison of counts across categories.

Another limitation of the flat category-keyword schema is that it provides an inflexible context under which keywords are associated with the categories. Categories, for example, cannot overlap to share common keywords. One consequence is that multiple keywords have to be created and labeled multiple times just to enable one keyword to be tracked under multiple categories. This multiple tracking scheme grows in complexity to the number of shared categories and keywords and is both unnatural and costly (from both a maintenance and performance standpoint). Another consequence of the inability of categories to share keywords is that once a flat category-keyword is defined, a new category cannot utilize counts gathered from keywords defined in an established category. This results in a schema that is difficult to adapt to changing business needs. A final limitation of the flat category-keyword schema is that, due to the inflexible context under which keywords are associated with the categories, integration with a high performance, cache-enabled system is often difficult and unnatural.

The above is a discussion of the deficiencies arising from the simple but limited organization of personalization tags or keywords in current personalization systems. Another major deficiency with current personalization systems is the way in which resources (e.g., digital objects, or digital documents) are associated with the personalization tags. Current systems allow one personalization tag to be associated with each resource. However, a resource frequently needs to be associated with multiple tags, where each association needs to be characterized with its own custom weight. For example, tennis balls might be associated with a 10% weight for juggling and a 90% weight for tennis.

The following embodiment shows how the current invention solves many of the limitations discussed above. The current invention creates: I) A more powerful and flexible organization of personalization tags, and II) A more flexible way to label contents, resources and digital objects with these personalization tags. The flexible organization of personalization tags enables cross categorization comparisons, the creation of more dynamic, flexible category schemes and easier integration with high performance, cache-enabled systems. The method of flexible labeling of contents enables digital documents and digital objects to be more accurately categorized, which allows user interests to be more accurately counted.

The following description shows a preferred embodiment of the current invention in the context of a high performance, cache-enabled system. Due to the complexity of the embodiment, it will be discussed in sections consisting of a database component, a cached page component, and a personalization component (including both the logging and interpreter components). The following sections describe each of these components in more detail.

### Database Component

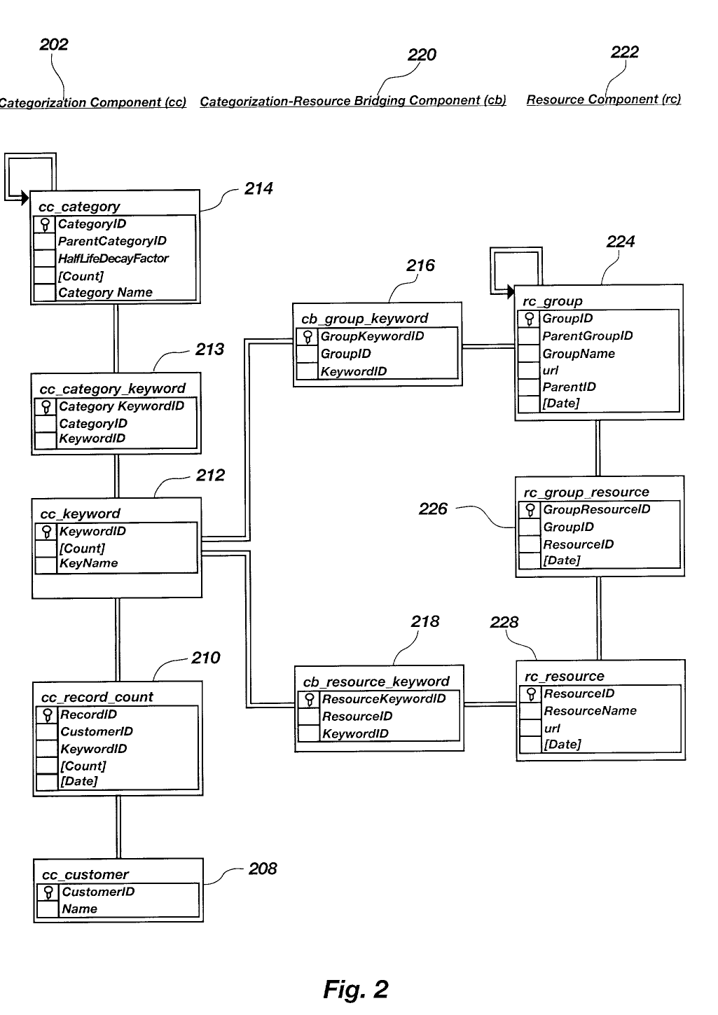

For the discussion of the database components, please refer to FIG. 2. The tables in the database schema are laid out in three columns, each of which corresponds to a database sub-component. In addition, the prefix of each table name identifies the component to which it belongs. For example, all tables in the first column belong to the categorization component and have a prefix of “cc_” in their name.

### Categorization Component

Referring to FIG. 2, the categorization component 202 forms the core database component of the current invention and consists of at least six categorization tables. The categorization tables form the depository where customer behavior (i.e., click-stream tracking) is logged. The tracking takes place within the context of a nested tree of categories and keywords. The nested tree is provided by the cc_keyword 212 and cc_category 214 tables. A category can contain subcategories and/or keywords. However, to ensure that the counts can be meaningfully compared within a category, it is preferable to have a category contain either all subcategories or keywords, but not a combination of both. If a category does contain a combination of subcategories and keywords, a mechanism for normalizing the counts between subcategories and keywords could be included to ensure meaningful comparison within a category. The cc category keyword 213 table in FIG. 2 allows a keyword to be simultaneously grouped under multiple categories. This allows for easier maintenance of the nested category-keyword structure and easier integration with cached systems as described in more detail below.

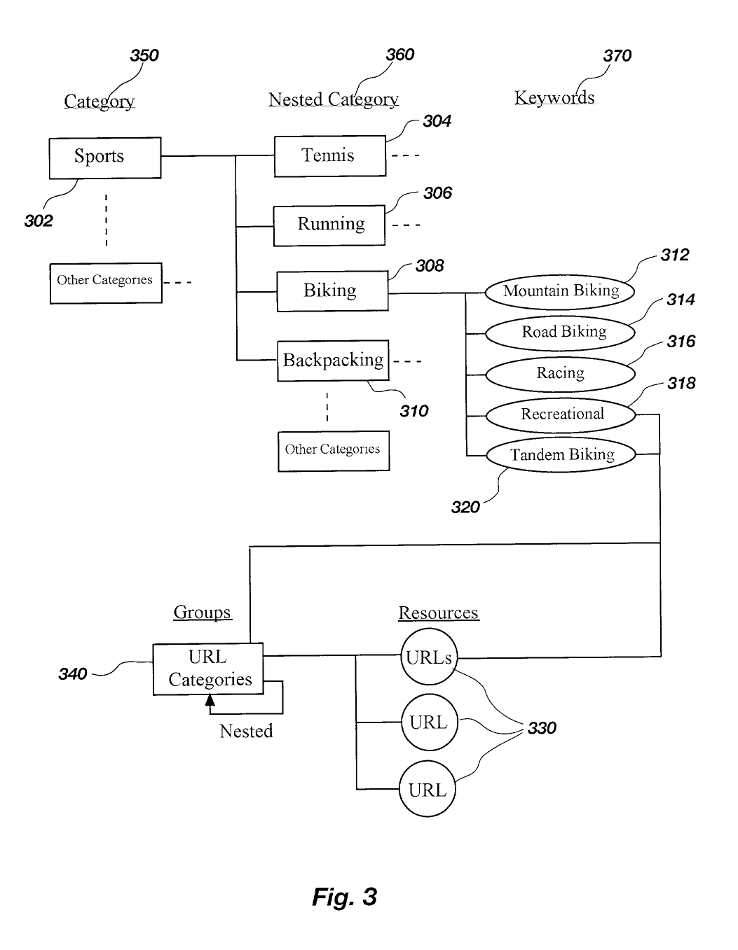

FIG. 3 illustrates the example of a sports category 302 which may be defined to contain the sub-categories: tennis 304, running 306, biking 308, and backpacking 310. The biking category, in turn, contains keywords such as mountain biking 312, road biking 314, racing 316, recreational 318, and tandem biking 320. It should be realized that the depth of the nested category is not limited but can be any number of levels desired by the system designer or users. In addition, the preferred embodiment of this invention only uses keywords at the lowest level of the hierarchy for a more uniform accounting of counts, but in general keywords and subcategories may be mixed together within a category provided a count normalization exists where appropriate.

FIG. 3 provides a good overview of the details of the system for personalizing digital objects and content associated with a web page. The personalization system includes content categories 350 that are nested hierarchically 360 and are linked to a plurality of keywords 370. Resources 330 are also associated with a plurality of keywords. The personalization system tracks each user's activities by storing an activity level for keywords associated with each resource. This allows the users' activities to be tracked as the user accesses the resources or URLs. A user's content preferences are determined based on the activity level recorded for the relevant keywords across multiple categories. When the personalization system has determined the user's content preferences, digital objects associated with a web page are delivered to users based on the user's content preferences across multiple categories. The following two examples serve as concrete examples for the use of the hierarchical categorization scheme just described.

There are two main ways to use the nested category keyword scheme for personalization in the current embodiment. The system or web server can query the database relative to a category context that contains more (sub) categories or a category context that contains only keywords. For example, in the latter case, one might make a query for the keyword with the maximum count under the “biking category” for a given user. If this “max keyword” turns out to be “mountain biking” for a certain user, then that user is probably a mountain biker.

The system can also query a level above the sports category (i.e., in the former case) to determine the sub-category where the user had the most activity by recursively summing up the activity level recorded for the corresponding child or sibling categories. This is a significant change in comparison to a flat category-keyword scheme, where queries can only be executed against the single layer of unrelated categories. With the nested category-keyword scheme, one can personalize based on higher “super categories” consisting of subcategories or keywords. For example, say the biking category belongs to a super-category called “outdoors” and consists of sibling categories “tennis,” “running,” and “backpacking.” Cross-categorizing is the ability to do a personalization analysis not just on biking but also on the super-category by comparing activity levels across sibling categories. A max count analysis of the “outdoors” category would return one of the four categories (tennis, running, biking, backpacking) and can, in the example, be used to indicate the type of sports in which the user is most interested. Cross-category personalization is a powerful concept. It allows personalization analyses to be done at a more abstract and useful level than personalization based on a flat category-keyword schema.

Besides allowing for hierarchical organization of categories, the current embodiment also teaches a more flexible way of organizing keywords within categories. Whereas the prior art teaches that each keyword must be assigned to one category, the current system allows a keyword to be associated with multiple categories. This models situations where categories may overlap and decreases the cost associated with modifying a personalization categorization model to meet changing business needs.

For example, suppose (as in the previous example) that a category “mountain bikes” consisting of the keywords “full suspension,” “hard tail,” and “rigid” has already been created and that due to varying marketing conditions, a new category “hybrids” consisting of keywords “touring” and “hard tail” needs to be created. In the previous model, the instantiation of the new category “hybrids” would have necessitated the creation of new keywords (with corresponding new branches of count histories) even if they already existed under another category. By contrast, the instantiation of the new categories in the current model would not have necessitated the creation of new keywords (or histories) because the keywords associated with categories are now allowed to overlap among categories. In the example above, the creation of the “hybrids” category would not have necessitated the creation of the “hard tail” keyword because the “hard tail” keyword (together with the associated history) can now be repeatedly associated such that it is a child of both the “mountain bike” and the “hybrid” category. A slightly different embodiment involves a situation where a category is to be retired. In that case, the relevant parts of the history belonging to the old category (to be retired) can be retained by associating the relevant keywords with other active categories.

Referring back to FIG. 2, while the cc_keyword 212 and cc_category 214 tables described above provide a framework to record customer behavior, the actual recording of the user's view count is stored in the cc_record_count table 210. All of a user's view counts are stored in the context of both the customer ID (or user ID) and the keyword ID. Accordingly, the activity associated with keywords is stored in a count representing the number of times a resource was accessed. For example, if a user views a web page tagged with a keyword referring to mountain bikes, a count is recorded that is keyed to both that keyword and the user's ID. This way we have a separate count of each keyword activity for every user or customer. The personalization system can also store a user activity level representing time or some other user activity metric.

### Categorization-Resource Component

Referring again to FIG. 2, the cb_group_keyword 216 and the cb_resource_keyword tables 218 are used here to illustrate one implementation of a method and system to allow for multiple-categorization. Multiple-categorization is a scheme where resources (e.g. items, web pages, components, or digital objects on a website) can be associated with multiple keywords. This flexibility is very important in cross promotions on a website. For example, it may be very useful to be able to categorize a water backpack promotion in multiple categories (e.g., under both the backpacking and the biking category). This ensures that the activity level is properly recorded since the user can be visiting the item due to either biking or backpacking interests. The current embodiment also allows the assignment of resources to multiple keywords to be weighted. This may be useful for the tagging of a document that might be 80% relevant to biking but only 20% to hiking, say.

### Resource Component

As illustrated by FIG. 2, the rc_group 224, rc_group_resource 226, and the rc_resource 228 tables create a nested tree table schema described here as the resource component 222. Resources are generally defined as digital documents that can be transmitted as generic digital objects and/or can be referenced by generic reference locators such as universal resource locators (URLs), which are sometimes known as web addresses or links. Essentially a resource is a digital document that contains information, digital objects, or a reference to digital objects accessible on a public or private network such as the Internet or an intranet. A group is a construct to group related resources together.

General categorization schemas are a commonly used and powerful method to organize generic information (e.g., Yahoo directory categories) and will be used here to showcase the power of cross-category personalization. In the following example, each resource (e.g., link) or each resource group can be tagged or associated with multiple keywords. Consider a news content model stored under a nested tree. A typical resource may be categorized under news>recreational news>outdoor recreation>bikes. Each bike news item can be tagged with keywords from personalization categories such as mountain bikes, road bikes, touring bikes, and hybrid bikes.

Attaching multiple keywords to a resource or group resource allows the system to personalize content across multiple categories. FIG. 3 illustrates how resources 330 are linked to multiple keywords 312-320. The resources are grouped 340 into nested tree schemas. Multiple categorization allows digital objects or documents to be categorized under multiple personalization categories or groupings. The main benefit of multiple categorization is more accurate tracking of user interests.

### Personalization Component

A logging component on the web server is responsible for updating the count in the database for each personalization keyword or tag found on a web page. Logging or the recording of user interests occurs after page generation (the generation or retrieval of the digital object to be delivered—i.e. an HTML page) and before page delivery or transmission of a digital object), as described in the flow chart of FIG. 1. In addition to updating the count in the database, the personalization component strips out the personalization tag before allowing the generated page to be sent to a users browser. The main advantage of the personalization component in the present system is the implementation of a weighted recording system for multiple categorization.

### Interpreter Component

The interpreter component consists of a library of routines to implement commonly used personalization queries. The following list shows the base functions on which more complicated queries can be built.

get_sorted_result(category[, community])→keyword or category list

get_sorted_keywords(category[, community ])→keywords or nothing

get_sorted_categories(category[, community])→categories or nothing

get_max(keyword or category list)→keyword or category

get_min(keyword or category list)→keyword or category

get_community( )→community list

For example, assume a user belongs to the recreational bicyclists community. To find the most popular type of biking for that community, one would call get_sorted_result(“biking”, “recreational bicyclists community”). Of course, the system would have already used the get_community( ) query in order to find out that the user belonged to the recreational bicyclists community.

The present interpreter component incorporates more functionality than a conventional interpreter component, because it includes the additional functionality for cross category personalization. Outside of these new functions, the module is used as in the prior art during the page generation phase for generating web content.

### Cached Component

Personalization involves operations that are inherently expensive and when executed by hardware can cause major degradations in server performance. The problem is that the personalization categorization schema does not always support the cache naming schema. The solution here is to create flexible category-keyword schemes that are easily mapped to the cached naming schema for the reusable, cached components.

Proper design of a category-keyword schema is important to the maintainability and reliability of the personalization system. In general, there are two ways to design category-keyword schemes. The first design criterion is business driven. Business driven categorization schemes are category-keyword schemes that map relatively directly to business concepts.

The second design criterion is functionally driven. Functionally driven categorization schemes are schemes that map relatively directly to properly designed cached components or digital object names. It is useful to map the categorization schemes to properly designed cached component names because this increases the speed of the system. This way the system keywords will match the cached component names and allow cached components to be found very quickly without employing dynamic regeneration of data. The problem is that often the keywords do not map directly to the cached component names.

The current invention teaches the use of a scheme that gives equal weight to both needs. Personalization needs to be business driven because it is built to satisfy real business needs. Moreover, personalization of content also needs to be function driven because this allows the content to be integrated into a caching scheme naturally to reduce the performance cost associated with personalization.

A suggested design plan includes several steps. First, design a categorization system based on business needs alone. Second, identify the various personalization services that are needed (e.g. promotions, news flashes, calendars, etc.) Third, investigate whether it makes sense to build the website with cached components named after these keywords. Cached components can be snippets of HTML that can be rearranged on a web page. If it doesn't make sense to compose the website with such cached components, the categorization should be redesigned.

For example, suppose we want to personalize our promotion services. Then in our biking category, the system should be analyzed to determine if it makes sense to personalize the website with promotional elements such as “mountain bike promotions,” “road bike promotions,” “touring bike promotions,” and “hybrid bike promotions.” If it makes sense, then that is an appropriate design scheme. However, if the system needs to use age-based promotions, then the caching schema would need to correspond more directly with the age categories. In this case, the system needs to incorporate some age related categories so a more natural mapping between it and the age based caching schema can be made.

An alternative to changing the categorization scheme outright is to allow a more flexible nesting of the hierarchical category-keyword schema, as discussed in the Database Component/Categorization Component section of the embodiment discussion earlier. In cases where the cached component scheme and the personalization categorization scheme don't match, a new personalization category can be created to match the cached component scheme and have the relevant combination of keywords or categories mapped to this new category. In the age-based example above, age-based categories can be reorganized, (e.g. “youth” and “adult”) by creating a “youth” cache-name category containing the “entry level” personalization category and “BMX” and the “adult” cache-name categories containing the “Mid level” and “Touring bikes” personalization categories.

Finally, it is relevant to note that for performance reasons, the hierarchical and flexible nesting of the personalization categorization scheme can lead to poor performance due to the extra processing inherent in retrieving data from such a data model. Caching alleviates most of the associated performance issues. To enhance the performance even more, a set of synopsis tables can be implemented that sum up the activity levels associated with the various categories. The synopsis tables would then be updated by data from the actual personalization categorization tables either periodically or during times when the system is idle.

### Conclusion

In conclusion, the current invention creates a more powerful and flexible organization of personalization tags and a more flexible way to label contents. The primary benefits derived from this invention are: 1) Cross categorization comparisons; 2) Lower maintenance costs through flexible categorization and classification; 3) Higher performance through better integration with caching systems; and 4) More accurate click-stream tracking through multiple categorization.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention with respect to current technologies and state of art, it will be apparent to those of ordinary skill in the art that numerous modifications, including, but not limited to, form, function and manner of operation, implementation and use may be made, without departing from the principles and concepts of the invention as set forth in the claims.

What is claimed is:

1. A method for personalizing digital objects and content associated with a web page sent to users across a network, comprising the steps of:
(a) accessing content categories that are arranged hierarchically and are linked to a plurality of keywords;
(b) associating at least one resource with a plurality of keywords;
(c) tracking each user's activities by storing an activity level for keywords associated with each resource, wherein the users' activities are tracked as the user accesses the resources;
(d) determining a user's content preferences based on the activity level for keywords across multiple categories; and
(e) delivering the digital objects associated with a web page to users based on the user's content preferences across multiple categories.

2. A method as in claim 1, wherein step (b) further comprises the step of associating a resource with a plurality of keywords to allow the system to personalize the digital objects delivered to a user based on the user's activity level for keywords in separate categories.

3. A method as in claim 1, further comprising the step of defining a weighting factor for each association between keywords and resources.

4. A method as in claim 3, further comprising the step of applying the weighting factor to the user's recorded activity level for the resource associated with the keyword.

5. A method as in claim 1, further comprising the step of reorganizing links between content categories and keywords.

6. A method as in claim 1, wherein step (b) further comprises the step of storing the resources, which refer to digital objects selected from the group of digital objects consisting of web pages, executable scripts, graphic objects, documents, and executable objects.

7. A method as in claim 1, further comprising the step of using resources that contain universal resource locators (URLs).

8. A method as in claim 1, further comprising the step of using resources that are digital documents.

9. A method for personalizing digital objects and content associated with a web page sent to users across a network, comprising the steps of:
(a) accessing content categories that divide digital objects into content groups;
(b) linking a plurality of keywords to a content category;
(c) storing a plurality of resources which refer to digital objects; and
(d) associating a resource with at least two keywords in separate categories to deliver the same digital objects to users based on users' activities in the separate categories.

10. A method as in claim 9, wherein step (c) further comprises the step of storing a plurality of resources, which refer to digital objects selected from the group of digital objects consisting of web pages, executable scripts, graphic objects, documents, and executable objects.

11. A method as in claim 9, further comprising the step of using the resource that is associated with at least two keywords, in order to provide flexible labeling for the resources.

12. A method as in claim 9, further comprising the step of using resources that contain universal resource locators (URLs).

13. A cache-enabled personalization system for delivering digital objects and content associated with a web page to a user, comprising:
(a) a hierarchy of categories;
(b) a plurality of keywords associated with the categories;
(c) a user activity logging component, associated with the plurality of keywords, configured to track user activity and store the user's activity as it relates to keywords;
(d) a plurality of resources, which refer to the digital objects, and are associated with at least two keywords to personalize delivery of the digital objects; and
(e) a caching data component, coupleable with the user activity logging component, which delivers cached digital objects to the user as the digital objects relate to multiple keywords across multiple categories.

14. A cache-enabled personalization system as in claim 13, wherein the digital objects are selected from the group of digital objects consisting of web pages, executable scripts, graphic objects, documents, and executable objects.

15. A system as in claim 13, further comprising a weighting factor for each association between keywords and resources.

16. A system as in claim 15, wherein the weighting factor is applied to the user's recorded activity level for the resource associated with the keyword.

17. A method as in claim 13, wherein the resources are digital documents.

18. A cache-enabled personalization system for delivering digital objects and content associated with a web page to a user, comprising:
(a) a hierarchy of categories that divide digital objects into content groups;
(b) a plurality of keywords linked to the categories;
(c) a user activity logging component, associated with the plurality of keywords, configured to track user's activity and store the activity as it relates to keywords;
(d) a plurality of resources, which refer to the digital objects, and are associated with at least two keywords in separate categories; and
(e) a caching data component, coupleable with the user activity logging component, which deliver the same digital objects to the user based on the user's activities in the separate categories.

19. A system as in claim 18, further wherein the digital objects are selected from the group of digital objects consisting of web pages, executable scripts, graphic objects, documents, and executable objects.

20. A system as in claim 18, wherein the resources contain universal resource locators (URLs).

21. A system as in claim 18, wherein links between content categories and keywords are dynamically reconfigurable.

22. An article of manufacture, comprising:
a computer usable medium having computer readable program code means embodied therein for personalizing digital objects and content associated with a web page sent to users across a network, the computer readable program code means in said article of manufacture comprising:
computer readable program code means for accessing content categories that are arranged hierarchically and are linked to a plurality of keywords;
computer readable program code means for associating a resource with a plurality of keywords;
computer readable program code means for tracking each user's activities by storing an activity level for keywords associated with each resource, wherein the users' activities are tracked as the user accesses the resources; and
computer readable program code means for determining a user's content preferences based on the activity level for keywords across multiple categories; and
computer readable program code means delivering the digital objects associated with a web page to users based on the user's content preferences across multiple categories.

23. A method for integrating a personalization system with a cache-enabled system for delivering digital objects and content associated with a web page to a user, comprising the steps of:
(a) creating a personalization categorization scheme which conforms to a defined business model;
(b) creating a cache component naming scheme associated with the digital objects and content; and
(c) conforming the personalization categorization scheme to the cache component naming scheme.

24. A method as in claim 23, further comprising the step of modifying the cache component scheme if non-conformance with the personalization categorization scheme is established.

25. A method as in claim 23, further comprising the step of modifying the personalization categorization scheme if non-conformance with the cache component scheme is established.

26. The method as in claim 23, further comprising the step of creating special purpose personalization categories that conform personalization categories to the cache component naming scheme.
